(19) United States
(12) Patent Application Publication
(10) Pub. No.: US 2019/0313680 A1
(43) Pub. Date: Oct. 17, 2019

(54) MODIFYING OR ENHANCING A FLAVOR OF FOOD AND BEVERAGE PRODUCTS

(71) Applicant: Tate & Lyle Ingredients Americas LLC, Hoffman Estates, IL (US)

(72) Inventors: Joshua Nehemiah Fletcher, Hoffman Estates, IL (US); John Smythe, Hoffman Estates, IL (US)

(73) Assignee: Tate & Lyle Ingredients Americas LLC, Hoffman Estates, IL (US)

(21) Appl. No.: 16/468,834

(22) PCT Filed: Dec. 13, 2017
(86) PCT No.: PCT/GB2017/053727

§ 371 Date: Jun. 12, 2019

Related U.S. Application Data
(60) Provisional application No. 62/433,607, filed on Dec. 13, 2016.

(51) Int. Cl. A23L 27/00; A23L 2/60; A23L 27/30; A23G 3/36

(52) U.S. Cl. CPC A23L 27/88; A23G 3/36; A23L 27/30; A23L 2/60

(57) ABSTRACT

The present invention relates to methods for modifying or enhancing a flavor of a food or beverage product, and to flavored food and beverage products With a modified or enhanced flavor.

### FIELD OF THE INVENTION

The present invention relates to methods for modifying or enhancing a flavor of a food or beverage product. The present invention also relates to flavored food and beverage products with a modified or enhanced flavor.

### BACKGROUND OF THE INVENTION

Flavoring agents are substances added to impart or help impart a flavor in food and beverage products. Synthetic and natural flavoring agents are therefore often added during the production of food and beverage products to give these products a desirable flavor. Many food and beverage products contain several of these flavoring agents, in addition to flavorants that may already be present in the ingredients which make up the food and beverage products. Achieving the correct balance of flavor in these products is very important for consumer acceptance.

In view of the above, there is a constant demand for new ways in which to modify or enhance a flavor of food and beverage products in order to make them more attractive to consumers.

Further, consumers typically show a preference for food and beverage products that are intensely flavored. Traditionally, methods for enhancing flavor include adding more of the flavoring agent(s) to the food and beverage products. However, flavoring agents can be very expensive. There is therefore a need for new cost effective methods for enhancing a flavor of food or beverage products.

Accordingly, an object of the present invention is to provide a method for modifying or enhancing a flavor of food and beverage products.

### SUMMARY OF THE INVENTION

According to a first aspect, the present invention provides a method of modifying or enhancing a flavor of a food or beverage product comprising including in said food or beverage product allulose in an amount below its sweetness threshold.

In an embodiment, the method is a method of enhancing a flavor of a food or beverage product.

In an embodiment, the allulose is included in the food or beverage product in an amount of about 2.695% by weight or less relative to the total weight of the food or beverage product.

In an embodiment, the allulose is included in the food or beverage product in an amount of about 2.20% by weight or less relative to the total weight of the food or beverage product.

In an embodiment, the allulose is included in the food or beverage product in an amount of about 0.10% by weight to about 2.20% by weight relative to the total weight of the food or beverage product. In an embodiment, the allulose is included in the food or beverage product in an amount of about 0.50% by weight to about 2.20% by weight relative to the total weight of the food or beverage product. In an embodiment, the allulose is included in the food or beverage product in an amount of about 1.00% by weight to about 2.20% by weight relative to the total weight of the food or beverage product. In an embodiment, the allulose is included in the food or beverage product in an amount of about 1.20% by weight to about 2.00% by weight relative to the total weight of the food or beverage product. In an embodiment, the allulose is included in the food or beverage product in an amount of about 1.20% by weight to about 1.80% by weight relative to the total weight of the food or beverage product. In an embodiment, the allulose is included in the food or beverage product in an amount of about 1.40% by weight to about 1.60% by weight relative to the total weight of the food or beverage product.

In an embodiment, the allulose is included in the food or beverage product in an amount of about 1.50% by weight relative to the total weight of the food or beverage product.

In an embodiment, the flavor is a sweet flavor. In an embodiment, the sweet flavor is a sweet aromatic flavor, in particular a sweet aromatic flavor perceived primarily or exclusively by retronasal smell. For example, the sweet aromatic flavor is selected from the group consisting of caramellic flavor, maple flavor, sugary flavor and cotton candy flavor, all of which flavors are perceived primarily or exclusively by retronasal smell. In an embodiment, the flavor is selected from the group consisting of caramellic flavor and cotton candy flavor. In an embodiment, the caramellic flavor is a salted caramel flavor.

In another aspect, there is provided the use of allulose in an amount below its sweetness threshold to modify or enhance a flavor of a food or beverage product.

The aforementioned embodiments of the methods of modifying or enhancing a flavor of a food or beverage product apply mutatis mutandis to the use of allulose in an amount below its sweetness threshold to modify or enhance a flavor of a food or beverage product.

In another aspect, there is provided a flavored food or beverage product comprising allulose in an amount below its sweetness threshold.

In an embodiment, the flavored food or beverage product comprises allulose in an amount of about 2.695% by weight or less relative to the total weight of the flavored food or beverage product.

In an embodiment, the flavored food or beverage product comprises allulose in an amount of about 2.20% by weight or less relative to the total weight of the flavored food or beverage product.

In an embodiment, the flavored food or beverage product comprises allulose in an amount of about 0.10% to about 2.20% by weight relative to the total weight of the flavored food or beverage product.

In an embodiment, the flavored food or beverage product comprises allulose in an amount of about 0.50% to about 2.20% by weight relative to the total weight of the flavored food or beverage product.

In an embodiment, the flavored food or beverage product comprises allulose in an amount of about 1.00% to about 2.20% by weight relative to the total weight of the flavored food or beverage product.

In an embodiment, the flavored food or beverage product comprises allulose in an amount of about 1.20% to about 2.00% by weight relative to the total weight of the flavored food or beverage product.

In an embodiment, the flavored food or beverage product comprises allulose in an amount of about 1.20% to about 1.80% by weight relative to the total weight of the flavored food or beverage product.

In an embodiment, the flavored food or beverage product comprises allulose in an amount of about 1.40% to about 1.60% by weight relative to the total weight of the flavored food or beverage product.

In an embodiment, the flavored food or beverage product comprises allulose in an amount of about 1.50% by weight relative to the total weight of the flavored food or beverage product.

The aforementioned embodiments of the methods of modifying or enhancing a flavor of a food or beverage product apply mutatis mutandis to the flavored food or beverage product comprising allulose in an amount below its sweetness threshold.

### DETAILED DESCRIPTION

The present invention is based on the finding that allulose, when included in a food or beverage product in an amount below its sweetness threshold, is capable of modifying or enhancing a flavor of said food or beverage product. In particular, when allulose is included in a food or beverage product in an amount below its sweetness threshold it has the ability to enhance a flavor of said food or beverage product.

The term “sweetness threshold” as used herein is the maximum concentration of a sweetener, such as allulose, that is not perceived as sweet on its own. The present specification also refers to allulose as being used in a food or beverage product in a “sub-sweetening amount” or at “sub-sweetening levels”. These terms are used to indicate that a food or beverage product contains allulose in an amount that would not in and of itself provoke any sweet taste in a subject.

A person of skill in the art will be able to determine readily the sweetness threshold of a sweetener such as allulose. Known methods for determining the sweetness threshold of a sweetener include using a two-alternative forced choice test against threshold levels of a given sweetener.

Described herein is a method for determining the sweetness threshold of allulose. The method is a two-alternative forced choice test against threshold levels of sweetness (ASTM Designation E2164-08: Standard Test Method for Directional Difference Test). This test is used to determine the amount of allulose at which its sweetness is less than that of the recognition threshold concentration of sucrose. The recognition threshold concentration of sucrose is 1.5% by weight in accordance with FEMA (Flavor Extracts Manufacturing Association) GRAS™ guidance.

In respect of food and beverage products, the use of a sweetener, such as allulose, in an amount below its sweetness threshold is generally referred to as using it at a flavor level. Accordingly, in the methods of the present invention, the allulose modifies or enhances a flavor (e.g. sweet flavor) of a food or beverage product, but does so while present in an amount that would not in and of itself provoke any sweet taste.

It can also be said that the allulose is being used as a flavor enhancer. As a person of skill in the art will readily appreciate, a flavor enhancer is a substance added to supplement, enhance or modify the original flavor of a food or beverage product, without imparting a characteristic flavor of its own.

The term “allulose” as used herein refers to a monosaccharide sugar of the structure shown as a Fischer projection in below Formula I. It is also known as “D-psicose”:

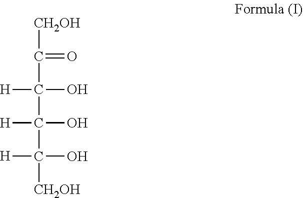 [SMILES: O=C(CO)C(O)C(O)C(O)CO]

Allulose is known as a “rare sugar”, since it occurs in nature in only very small amounts. It provides around 70% of the sweetness of sucrose, but only around 5% of the calories (approximately 0.2 kcal/g). It may therefore essentially be considered to be a ‘zero calorie’ sweetener.

All amounts given in % by weight are quoted relative to the total weight of a food or beverage product unless specifically stated otherwise. Thus, where components are provided other than in their pure form, the amount added/included should be adjusted to provide the required amount of the pure form on a dry solids basis. For example, where allulose is provided as a syrup, the amount of syrup used should be adjusted to supply the required amount of allulose dry solids on a % by weight basis.

The present invention relates to methods for modifying or enhancing a flavor of food or beverage products.

Flavor is associated with the taste and aroma of a food or beverage product. While informally taste and flavor are used interchangeably, the terms in fact have different meanings. Taste is a sensation that is produced when a substance interacts with a taste receptor in the oral cavity. The five established taste dimensions are: sweet, salty, bitter, sour and umami. Flavor, however, is an integrated sensory experience determined primarily by a combination of taste and smell, but which may also be influenced by other sensory components such as mouthfeel. As such, flavor may be modified by modifying one or more of these sensory components. According to the present invention, flavor is modified or enhanced primarily or exclusively by modifying aroma, particularly by modifying aroma perceived by retronasal smell (which is perceived when smell molecules enter the nasal passage via the mouth, particularly when chewing).

In view of the fact that flavor is an integrated sensory experience, it is possible for one sensory component, particularly aroma, to evoke a particular flavor even in the absence of other sensory components. For example, the aroma of a sweet food such as cotton candy will evoke a sweet flavor, even in the absence of a sweet taste. As such, flavoring agents used to provide such flavors in food or beverage products are often described as “sweet flavors”, even though the flavoring agents themselves will often not have a sweet taste.

Incorporating allulose at an amount below its sweetness threshold in food or beverage products may modify or enhance a flavor of said food or beverage products by altering flavor attributes such as intensifying specific flavor characteristics, reducing specific flavor characteristics, masking of off-notes or bitterness, or changing the time onset and duration of the perception of specific aspects of the flavor. For example, the allulose may modify or enhance a flavor of said food and beverage products by altering the perception of flavor by the consumer. The allulose may alter the perception of a flavor by altering the quality or intensity of the flavor, for example by enhancing, strengthening, softening or sharpening the flavor. The allulose may also modify any aspect of the temporal profile of the flavor of the food or beverage product. Without wishing to be bound by theory, it is believed that allulose may enhance the flavor of a beverage by suppressing undesirable antagonistic flavors.

Where content amounts are described herein by reference to numerical ranges, all intermediate amounts encompassed by said ranges are expressly disclosed herein, as are all intermediate ranges based on said intermediate amounts.

According to a first aspect, the present invention provides a method of modifying or enhancing a flavor of a food or beverage product comprising adding to said food or beverage product allulose in an amount below its sweetness threshold. The allulose is in an amount below its sweetness threshold after incorporation into the food or beverage product.

In an embodiment, the method is a method of modifying a flavor of a food or beverage product. In an embodiment, the method is a method of enhancing a flavor of a food or beverage product. In an embodiment, the method is a method of modifying or enhancing a flavor of a beverage product. In an embodiment, the method is a method of modifying a flavor of a beverage product. In an embodiment, the method is a method of enhancing a flavor of a beverage product.

The allulose may enhance a flavor of a food or beverage product. The allulose may enhance the non-taste elements of a flavor of a food or beverage product. For example, the allulose may enhance a flavor of a food or beverage product by intensifying said flavor. The allulose may enhance a flavor of a food or beverage product by intensifying the non-taste elements of said flavor.

As already mentioned, incorporating allulose in an amount below its sweetness threshold in a food or beverage product can modify or enhance a flavor of said food or beverage product. The presence of sub-sweetening amounts of allulose in a food or beverage product may also increase the preference for said food or beverage product over the same food or beverage product that does not comprise allulose, or that does not comprise allulose in an amount below its sweetness threshold.

Unless otherwise stated, any reference to the amount of allulose used in the methods of the present invention is with respect to the amount of the compound allulose itself (i.e. the pure allulose amount), and not to the amount of a source containing allulose (unless, of course, the source consists of 100% pure allulose).

There is no particular limitation on the source of allulose that can be used in the present invention. The source of allulose used in the methods described herein may comprise, consist essentially of, or consist of allulose. For example, the allulose source used in accordance with the present invention may have a purity (expressed as weight % allulose, based on the total weight of the allulose source) of at least 50%, at least 60%, at least 70%, at least 80%, at least 90%, at least 95%, at least 96%, at least 97%, at least 98%, at least 99%, at least 99.5% or at least 99.9%. The allulose source may, in one embodiment, be 100% pure allulose. The allulose source may even be an admixture of allulose and one or more other sugars, such as fructose, glucose, sucrose, allose, tagatose or the like. Liquid forms of allulose may be used in the present invention. For example, the allulose may be in a syrup form such as the one described in WO 2016/135458. Syrups comprising allulose may contain allulose in varying amounts on a dry solids (ds or DS) basis (typically from about 70 to about 90% by weight). If employed in solid form, amorphous or crystalline allulose may be used. The allulose may have any crystal morphology, particle size, crystal shape or other physical characteristics that may be suitable in view of the intended food or beverage use. For example, a crystalline form of allulose which may be used in the present invention can be prepared by the method described in U.S. 62/414,280.

In the methods of the present invention, the allulose is included in the food or beverage products such that it is present in the food or beverage product in an amount below its sweetness threshold.

In an embodiment, the allulose is included in the food or beverage product in an amount of about 2.695% by weight or less relative to the total weight of the food or beverage product. For example, the method may comprise including allulose in a food or beverage product in an amount of 0.10, 0.20, 0.30, 0.40, 0.50, 0.60, 0.70, 0.80, 0.90, 1.00, 1.10, 1.20, 1.30, 1.40, 1.50, 1.60, 1.70, 1.80, 1.90, 2.00, 2.10, 2.20, 2.30, 2.40, 2.50, 2.60, 2.65, 2.69% by weight or less relative to the total weight of the food or beverage product, as well as all intermediate values.

In an embodiment, the allulose is included in the food or beverage product in an amount of 0.10% by weight to about 2.695% by weight relative to the total weight of the food or beverage product. For example, the allulose may be included in the food or beverage product in an amount of about 0.20% to about 2.695%, about 0.30% to about 2.695%, about 0.40% to about 2.695%, about 0.50% to about 2.695%, about 0.60% to about 2.695%, about 0.70% to about 2.695%, about 0.80% to about 2.695%, about 0.90% to about 2.695%, about 1.00% to about 2.695%, about 1.10% to about 2.695%, about 1.20% to about 2.695%, about 1.30% to about 2.695% or about 1.40% to about 2.695% % by weight relative to the total weight of the food or beverage product, as well as all intermediate values.

The allulose may be included in the food or beverage product in an amount of about 1.40% to about 2.60%, about 1.40% to about 2.50%, about 1.40% to about 2.40%, about 1.40% to about 2.30%, about 1.40% to about 2.20%, about 1.40% to about 2.10%, about 1.40% to about 2.00%, about 1.40% to about 1.90%, about 1.40% to about 1.80%, about 1.40% to about 1.70%, about 1.40% to about 1.60%, about 1.45% to about 1.55%, about 1.46% to about 1.54% or about 1.47% to about 1.53%, about 1.48% to about 1.52% or about 1.49% to about 1.51% by weight relative to the total weight of the food or beverage product, as well as all intermediate values.

The allulose may be included in the food or beverage product in an amount of about 1.00% to about 2.20%, about 1.00% to about 2.10%, about 1.00% to about 2.00%, about 1.10% to about 2.00%, about 1.10% to about 1.90%, about 1.20% to about 1.90%, about 1.20% to about 1.80%, about 1.30% to about 1.80%, about 1.30% to about 1.70% or about 1.30% to about 1.60% by weight relative to the total weight of the food or beverage product, as well as all intermediate values

In an embodiment, the allulose is included in the food or beverage product in an amount of about 1.50% by weight relative to the total weight of the food or beverage product.

As will be appreciated by a person of skill in the art, the allulose may be included by any means during the production of the food or beverage product. The allulose may be added together with one or more flavoring agents during the production of the food or beverage product. For example, a flavoring composition comprising allulose and one or more flavoring agents could be added during the production of the food or beverage product. Alternatively, the allulose may be added to the “finished” product, for example, by blending a source of allulose with the product.

In the case of beverage products which require dilution prior to consumption by a consumer (e.g. beverage concentrates (including, but not limited to, liquid concentrates and syrups as well as non-liquid ‘concentrates’, such as freeze-dried and/or powder preparations)), or in the case of pre-made mixes which require reconstitution and possibly further processing to produce the final food or beverage product (e.g. pre-made sweet bakery mixes for preparing sweet bakery products or pre-made bread mixes for preparing bread products) the allulose will be in an amount below its sweetness threshold in the finished food or beverage product (e.g. the final made-up beverage product or baked food product).

When used herein, the term “finished food or beverage product” is intended to mean the finished food or beverage product which is consumed by a consumer. In the case of liquid concentrates, this will be the product after dilution to the concentration indicated by the manufacturer on the packaging. In the case of pre-made mixes, the finished product is the product obtained after reconstitution and possible further processing (e.g. baking) in accordance with the manufacturer's instructions.

Food or beverage products which may be contemplated in the context of the present invention include baked goods; sweet bakery products (including, but not limited to, rolls, cakes, pies, pastries, and cookies); pre-made sweet bakery mixes for preparing sweet bakery products; pie fillings and other sweet fillings (including, but not limited to, fruit pie fillings and nut pie fillings such as pecan pie filling, as well as fillings for cookies, cakes, pastries, confectionary products and the like, such as fat-based cream fillings); desserts, gelatins and puddings; frozen desserts (including, but not limited to, frozen dairy desserts such as ice cream—including regular ice cream, soft serve ice cream and all other types of ice cream—and frozen non-dairy desserts such as non-dairy ice cream, sorbet and the like); carbonated beverages (including, but not limited to, soft carbonated beverages); non-carbonated beverages (including, but not limited to, soft non-carbonated beverages such as flavored waters and sweet tea or coffee based beverages); beverage concentrates (including, but not limited to, liquid concentrates and syrups as well as non-liquid ‘concentrates’, such as freeze-dried and/or powder preparations); yogurts (including, but not limited to, full fat, reduced fat and fat-free dairy yogurts, as well non-dairy and lactose-free yogurts and frozen equivalents of all of these); table-top sweeteners (e.g., a dry table-top sweetener, which may take the form of tablets, granules or a powder, or a liquid table-top sweetener); snack bars (including, but not limited to, cereal, nut, seed and/or fruit bars); bread products (including, but not limited to, leavened and unleavened breads, yeasted and unyeasted breads such as soda breads, breads comprising any type of wheat flour, breads comprising any type of non-wheat flour (such as potato, rice and rye flours), gluten-free breads); pre-made bread mixes for preparing bread products; sauces, syrups and dressings; sweet spreads (including, but not limited to, jellies, jams, butters, nut spreads and other spreadable preserves, conserves and the like); confectionary products (including, but not limited to, jelly candies, soft candies, hard candies, chocolates and gums); sweetened breakfast cereals (including, but not limited to, extruded (kix type) breakfast cereals, flaked breakfast cereals and puffed breakfast cereals); and cereal coating compositions for use in preparing sweetened breakfast cereals.

In preferred embodiments, the flavor to be modified or enhanced is a sweet flavor. For example, the sweet flavor may be a sweet aromatic flavor, in particular a sweet aromatic flavor perceived primarily or exclusively by retronasal smell.

Types of sweet aromatic flavor that can be modified by including sub-sweetening amounts of allulose in a food or beverage product include, but are not limited to, caramellic flavors, maple flavors, sugary flavors or cotton candy flavors, all of which flavors are perceived primarily or exclusively by retronasal smell. Caramellic flavors include, but are not limited to, salted caramel flavors.

In an embodiment, the method is a method of modifying or enhancing a salted caramel flavor in a beverage product comprising including in said beverage product allulose in an amount below its sweetness threshold. For example, the method may be a method of enhancing a salted caramel flavor in a beverage product comprising including in said beverage product allulose in an amount below its sweetness threshold.

In an embodiment, the method is a method of modifying or enhancing a cotton candy flavor in a beverage product comprising including in said beverage product allulose in an amount below its sweetness threshold. For example, the method may be a method of enhancing a cotton candy flavor in a beverage product comprising including in said beverage product allulose in an amount below its sweetness threshold.

In an embodiment, the method is a method of enhancing a cotton candy flavor and/or salted caramel flavor in a beverage product comprising including in said beverage product allulose in an amount below its sweetness threshold.

As a person of skill in the art will appreciate, flavoring agents are substances added to impart or help impart a flavor in a food or beverage product. The following lists of flavoring agents are known in the art and have been prepared from databases compiled by “The Good Scents Company” (www.thegoodscentscompany.com),

Examples of flavoring agents that are known to impart or help impart a sweet flavor include acetone alcohol, adonitol, agave flavor, allyl hexanoate, 4-amino-5,6-dimethyl thieno(2,3-d)pyrimidin-2(1H)-one hydrochloride, 3-((4-amino-2,2-dioxido-1H-2,1,3-benzothiadiazin-5-yl)oxy)-2,2-dimethyl-N-propyl propanamide, iso-amyl phenyl acetate, star anise seed oil terpeneless, benzyl salicylate, iso-butyl acetoacetate, iso-butyl 2-butenoate, iso-butyl isovalerate, caramel dione, caramel furanone, caramel furanone solution, caramel pentadione, Cocos nucifera fruit juice, beta-cyclodextrin, cyclotene, cyclotene hydrate, 5,5′-diacetyl-dithienyl-2,2′-methane, dihydroxyacetone (monomer), 3′,7-dihydroxy-4′-methoxyflavan, 2,5-dimethyl-3-acetyl-pyrrole, ethyl benzoate, ethyl benzoyl acetate, ethyl cyclopentenolone, ethyl furaneol, ethyl 3-hydroxyhexanoate, ethyl 3-(2-hydroxyphenyl) propionate, ethyl lactate, ethyl maltol, ethyl methyl-para-tolyl glycidate, ethyl myristate, ethyl octanoate, ethyl phenyl acetate, ethyl pyruvate, ethyl salicylate, ethyl isovalerate, ethyl vanillin propylene glycol acetal, eugenol, iso-eugenol, iso-eugenyl phenyl acetate, dextro-fagomine, ferrous lactate, 2-furyl pentyl ketone, genet absolute, geranyl isobutyrate, guaiacyl phenyl acetate, heliotropyl acetone, 2-hexen-1-ol, (Z)-3-hexen-1-yl salicylate, hexyl benzoate, alpha-hexyl cinnamaldehyde, honey enhancer, honey flavor, hydroxycitronellal, hydroxycitronellol, 2-hydroxymethyl pyrazine levodopa, dextro-limonene, lovage tincture, maltitol, maltol, maltyl isobutyrate, maltyl propionate, maple distillates, maple furanone, 2-methoxy-4-vinyl phenol, para-methyl acetophenone, methyl anthranilate, 2-methyl butyl acetate, methyl isobutyrate, N-(2-methyl cyclohexyl)-2,3,4,5,6-pentafluorobenzamide, 2-methyl-5,7-dihydrofuro-[3,4-d]-pyrimidine, 5-methyl furfural, 1-(5-methylfuryl)-3-pentanone, methyl heptanoate, methyl salicylate, methyl valerate, 4-methyl-2-(1-methyl-1-butenyl)-1,3-dioxolane, molasses distillates, molasses flavor, beta-naphthyl methyl ketone, nephelium lappaceum fruit, (E)-2-octenal, octyl propionate, levo-ornithine hydrochloride, phenethyl tiglate, phthalide, pineapple hydroxyhexanoate, sweet potato flavor, praline flavor, prenyl acetate, levo-proline, propenyl guaethol, propyl butyrate, iso-propyl butyrate, propyl isobutyrate, iso-propyl formate, propyl heptanoate, propyl phenyl acetate, iso-propyl phenyl acetate, propyl propionate, propylene glycol, pyruvaldehyde, sodium 2-(4-methoxyphenoxy) propionate, strawberry furanone, strawberry furanone acetate, strawberry furanone solution, strawberry glycidate 1, strawberry glycidate 2, sugar distillates, sugar extenders, sugar flavor, brown sugar flavor, burnt sugar flavor, sweet & sour candy flavor, sweet & sour flavor, terpinyl propionate, tetrahydrofurfuryl acetate (E)-tiglic acid, 2,5,7-trimethyl-5,7-dihydrofuro-[3,4-d]-pyrimidine, tyramine, vanilla aromatica fruit extract, vanilla bean absolute (vanilla planifolia), vanilla bean aromatica, vanilla bean planifolia, vanilla concentrate, vanilla oleoresin bali, vanilla oleoresin bourbon, vanilla resinoid, vanilla tahitensis fruit extract, vanillin propylene glycol acetal, para-vanillyl alcohol, vanillyl isobutyrate, 2,6-xylenol, ammonium isovalerate (30% in propylene glycol), aristotelia chilensis fruit juice, aristotelia chilensis leaf extract, benzyl amyl carbinol, benzyl butyl carbinol, benzyl isobutyrate, clary sage absolute, cocoa pentenal, decyl methanesulfinate, ethyl para-anisate, ethyl butyrate, ethyl formate, (E,E)-ethyl sorbate, ethylene brassylate, furfural, furfuryl alcohol, guajillo chile oleoresin, (E)-2-heptenal, hexyl isobutyrate, levulinic acid, lime essence oil, lime pyran, menthyl isovalerate, para-methoxycinnamaldehyde, methyl R-3-acetoxyhexanoate, 3-methyl butyl 2-furyl butyrate, methyl heptadienone, methyl propanesulfinate, (E,E)-methyl sorbate, delta-octalactone, phenethyl alcohol, (E)-propyl 2-furan acrylate, iso-propyl 2-methyl butyrate, iso-propyl octanoate, propylene glycol diacetate, rose oil (rosa damascena) russia, rose oil (rosa damascena) turkey, tropical ionone, vanilla carboxylate, veratraldehyde, 3,4-xylenol, acetoin, 2-acetyl-benzothiophene, 2-acetyl-5-methyl thiophene, iso-butyl angelate, iso-butyl formate, bittersweet chocolate flavor, (E)-2-decenoic acid, 2,6-dimethyl naphthalene, ethyl acetate, ethyl decanoate, ethyl 3-(2-furyl) propanoate, 2-ethyl-1-hexanol, ethyl 3-hexenoate, ethyl propionate, ethyl valerate, ethyl vanillin, dextro-fenchone, fusel oil, 3-heptyl dihydro-5-methyl-2(3H)-furanone, hexyl lactate, alpha-ionol, linalyl isobutyrate, lucuma flavor, massoia bark oil (CO₂ extract), alpha-methyl cinnamaldehyde, methyl 3-nonenoate, methyl (E)-3-nonenoate, methyl (E)-2-octenoate, mint lactone, (E,Z)-3,6-nonadien-1-yl acetate, 2-octen-1-ol, (E)-2-octen-1-ol, 2-pentanone, propyl hexanoate, 3-propylidene phthalide, rhodinyl phenyl acetate, shoyu furanone, terpinyl valerate, tolualdehydes (mixed ortho, meta, para), (E,Z,Z)-2,4,7-tridecatrienal, tuberose absolute (from pommade), para-vanillic acid, vanillylidene acetone, anethum graveolens herb tincture, butyl butyrate, cucumber essence, 2-ethyl butyraldehyde, 4-ethyl guaiacol, ethyl 3-oxohexanoate, S-ethyl thioacetate, furfuryl valerate, (E)-2-hexenoic acid, hexyl acetate, 1-(2-hydroxy-4-methoxyphenyl)-3-(pyridin-2-yl)propan-1-one, methional diethyl acetal, alpha-methyl-(E)-cinnamaldehyde, methyl 3-hexenoate, nonanoic acid, octahydrocoumarin, peppermint oil (America), peppermint oil (idaho), perillaldehyde, 4-phenyl-3-buten-2-ol, rose butanoate, 2,2,3-trimethyl cyclopentane ethanol, benzyl acetate, iso-butyl anthranilate, divanillin, (Z)-4-hepten-1-ol, neryl isobutyrate, nonanol, octyl butyrate, iso-valeric acid, vanillin, para-acetanisole, acetophenone, iso-butyl butyrate, butyl isovalerate, ethyl cinnamate, hexyl phenyl acetate, methyl phenyl acetate, ketoisophorone (2,6,6-trimethylcyclohex-2-ene-1,4-dione), (Z)-3-hexenyl methyl ether and vanillyl acetate.

Examples of flavoring agents that are known to impart or help impart a sweet aroma include acetyl longifolene, star anise seed oil terpeneless, caramel dione, caramel furanone, caramel furanone solution, caramel pentadione, coffee dione, cyclotene hydrate, ethyl cyclopentenolone, ethyl furaneol, 4-ethyl-2-hydroxy-3-methyl-2-cyclopenten-1-one, ethyl maltol, ethyl vanillin propylene glycol acetal, evernia prunastri lichen, hexyl 2-methyl-3-pentenoate, homalomena rubescens root oil, honey specialty, 3(2)-hydroxy-5-methyl-2(3)-hexanone, 2-hydroxy-3,5,5-trimethyl-2-cyclopenten-1-one, maltol, maltyl isobutyrate, maltyl propionate, maple furanone, melaleuca quinquenervia water, mesitene lactone, 2-methoxy-3,5-dimethyl-2-cyclopenten-1-one, 2-methyl-5,7-dihydrofuro-[3,4-d]-pyrimidine, (Z)-4-octen-1-ol, 2-pentanoyl furan, 3-pentyl bicyclo[3.2.1]octan-2-one, periploca sepium root oil, (E)-2-phenyl-1(2)-propene-1-yl acetate, phthalide, pineapple hydroxyhexanoate, blackpoplar bud oleoresin, Psidium guajava fruit, rose absolute morocco, rose concrete (rosa damascena), saffron resinoid, sandalwood oil CO₂ extract, beta-sinensal, spikenard oil, spikenard oil CO₂ extract, strawberry furanone, strawberry furanone acetate, strawberry furanone butyrate, strawberry furanone solution, sugar fragrance, brown sugar fragrance, surfleurs d′oranger oil, sweet pea absolute, sweet pea fragrance, tamarindus indica extract, taraxacum officinale leaf tincture, tilia cordata flower, toffee furanone, tolu balsam oil, 2,5,7-trimethyl-5,7-dihydrofuro-[3,4-d]-pyrimidine, undecanal propylene glycol acetal, isovaleraldehyde propylene glycol acetal, vanilla aromatica fruit extract, vanilla bean aromatica, vanilla bean planifolia, french vanilla fragrance, vanilla resinoid, vanilla tahitensis fruit extract, vanillin propylene glycol acetal, vanillyl isobutyrate, woodruff absolute, 2-acetyl-3,5-dimethyl furan, isoamyl acetoacetate, amyl hexanoate, isoamyl hexanoate, amyl octanoate, arnica flower oil, 2-butoxyethyl acetate, cabreuva wood oil, caraway seed oleoresin, carrot weed oil, citronellyl cinnamate, cyclohexyl crotonate, 2,5-dibutyl-4-methyl oxazole, 1,3-dihydroxyacetone (dimer), epoxyoxophorone, 2-ethyl butyl 2-butenoate, 1-ethyl-2-methyl propyl 3-butenoate, ethyl pentadecanoate, eucalyptus leucoxylon leaf oil algeria, fenchyl acetate, furfuryl ethyl ether, gingergrass oil, green carboxylate, green heptenal, gurjun balsam oil, heliotropyl diethyl acetal, 2-hexyl-5 or 6-keto-1,4-dioxane, alpha-ionol, ivy carbaldehyde/methyl anthranilate Schiff's base, juniper berry concrete, lilac perfume base, Matricaria chamomilla flower oil, (−)-menthone, musk gx (1,3,4,6,7,8-hexahydro-4,6,6,7,8,8-hexamethylcyclopenta(g)-2-benzopyran) 50% in benzyl benzoate, musk nonane (1,8-dioxacycloheptadecan-9-one), 2-nonanone, nonyl benzoate, (E,E)-2,6-alloocimene ((4E,6E)-2,6-dimethylocta-2,4,6-triene), phenethyl acetate, phenoxyacetic acid, phenyl acetaldehyde, phenyl acetaldehyde 2,3-butylene glycol acetal, phenyl ethylidene acetone, 1-phenyl-2-pentanol, 2-propenyl-para-cymene, 4-propenyl syringol, propyl butyrate, propyl propanesulfinate, propyl isovalerate, 3-propylidene phthalide, isopulegyl acetate, isosafrole, strawberry furanone methyl ether, 1,3,4-trimethyl pentyl 2-butenoate, 1,2,2-trimethyl propyl 2-butenoate, tropical indene, tuberose absolute (from concrete), tuberose absolute (from pommade), turmeric root oil china, vanilla bean oil (vanilla planifolia), vanilla planifolia fruit infusion, annuswormwood oil france, acetaldehyde benzyl 2-methoxyethyl acetal, acetaldehyde hexyl isoamyl acetal, acetyl tributyl citrate, agarwood oil (aetoxylon sympetalum), isoamyl butyrate, angelica seed oil, benzaldehyde propylene glycol acetal, brachyleana hutchinsii wood oil, isobutyl anthranilate, isobutyl propionate, alpha-campholenic alcohol, chamomile oil morocco, (E)-cinnamic acid, citral, cocoa essence, (R)-delta-decalactone, 9-decen-5-olide-2,4-diethyl-5-propyl oxazole, 2,5-diethyl tetrahydrofuran, 3′,4′-dimethoxyacetophenone, (R)-delta-dodecalactone, elder flower absolute (sambucus canadensis and s. nigra), endo-ethyl bicyclo(2.2.1)-5-heptene-2-carboxylate, ethyl butyryl lactate, (S)-2-ethyl hexanoic acid, ethyl 5-hydroxydecanoate, ethyl methyl anthranilate, 10-epi-gamma-eudesmol, isoeugenyl formate, eugenyl phenyl acetate, (E)-beta-farnesene, white frangipani concrete, freesia acetate, gardenia absolute, grains of paradise oil, 2-heptanol, 3-heptanone, 4-heptanone, hexanal butane-2,3-diol acetal, (Z)-3-hexen-1-yl acetate, (Z)-3-hexen-1-yl lactate, sec-hexyl alcohol, 4-hydroxyphenethyl alcohol, 3-hydroxy-4-phenyl-2-butanone, cis-2-hydroxy-3,4,5-trimethyl-2-cyclopenten-1-one, trans-2-hydroxy-3,4,5-trimethyl-2-cyclopenten-1-one, beta-ionone, kewda oil, lavender oil, lime oil expressed florida, (3S,6S)-(Z)-linalool oxide (pyranoid), marigold oil mexico, massoia bark oil CO₂ extract, menthyl isovalerate, 3-mercapto-3-methyl butanol, 3-mercapto-3-methyl-1-butyl acetate, methionol, para-methoxycinnamaldehyde, (E)-para-methoxycinnamaldehyde, methyl 2-hydroxy-4-methyl valerate, 2-methyl naphthalene, methyl octanoate, methyl sandal, 5-methyl tetrahydrofuran-3-one, musk cyclopentenyl propionate ([2,2-dimethyl-3-(2-methyl-5-prop-1-en-2-yl-1-cyclopentenyl)propyl]propanoate), musk decanolide (1,6-dioxacycloheptadecan-7-one), musk gx (1,3,4,6,7,8-hexahydro-4,6,6,7,8,8-hexamethylcyclopenta(g)-2-benzopyran) 100%, narcissus flower absolute, gamma-nonalactone, nonyl anthranilate, isooctyl acetate, octyl oxyacetaldehyde, opoponax resinoid replacer, peach pivalate, pear valerate, petitgrain combava oil, sesquiphellandrene, phenethyl lactate, phenethyl phenyl acetate, phenethyl tiglate, 4-phenyl-2-butyl acetate, isophorone, ketoisophorone, pineapple pentenoate, 2-isopropoxy-3(5)-methyl pyrazine, propyl mercaptan, 2-isopropyl-4-methyl-3-thiazoline, isopropyl propionate, propyl pyruvate, propylene glycol dibutyrate, rhododendron anthopogon leaf oil, rose leaf absolute (rosa centifolia), styryl acetate, tea leaf absolute, (R)-tonka furanone, (R)-N,N,alpha-trimethyl benzyl amine, 2,6,6-trimethyl-2-hydroxycyclohexanone, tuberose acetate, (R)-delta-undecalactone, (R)-gamma-undecalactone, (S)-delta-undecalactone, (S)-gamma-undecalactone, valerian rhizome absolute, vanilla bean absolute (vanilla planifolia), vanilla tahitensis fruit absolute, vanilla tahitensis fruit absolute CO₂ extract, vanilla tahitensis fruit oil CO₂ extract, para-vanillic acid, vanillin hexylene glycol acetal, dextro-xylose, ylang ylang flower absolute, acetyl ethyl tetramethyl tetralin replacer, 9-acetyl-5-methyl-tricyclo[6.2.1.0.sup.2,7]undec-4-ene, allyl isononylate, isoamyl decanoate, amyl propionate, amyl salicylate, homoanisaldehyde, laevo-borneol, isobornyl acetate, isobornyl phenyl acetate, isobutyl formate, 2-butyl furan, 1-isobutyl-2-methyl butyl 2-butenoate, alpha-campholene acetate, capsicum oleoresin, carvyl propionate, (Z)-civet decenone, 2,6-dimethyl-3-oxatricyclo(4.2.1.0*2,4*)nonane, 1,3-dithiolane, elecampane root absolute, delta-elemene, alpha-ethoxy-ortho-cresol, ethyl (Z)-4-heptenoate, ethyl 3-mercaptobutyrate, 1-ethyl-2-methyl propyl 2-butenoate, ferula assa-foetida absolute, filbert heptenone, furfuryl alcohol, ginger root absolute; ginsene, grapefruit oil folded florida, isogreen methanoindene, guaiacwood oil 20% in gurjun balsam oil, (S)-gamma-heptalactone, 3-heptyl acetate, (S)-gamma-hexalactone, (E)-2-hexenoic acid, 3-hexenyl 2-methyl butyrate, hexoxyacetaldehyde dimethyl acetal, hexyl formate, hexyl 2-furoate, hinoki root oil, hop oil, hydroxymethyl hexyl ethyl ketone, juniper muscone, laurel bark oil, laurel stem oil, lawsonia inermis flower absolute, levisticum officinale herb oil, (Z)-linalool oxide (furanoid), litsea cubeba oil terpenes, melissa oil (slovak republic), laevo-menthyl isobutyrate, methyl benzyl acetate (mixed ortho-,meta-,para-), 2-methyl butyl propionate, alpha-methyl-(E)-cinnamaldehyde, 6-methyl heptanal, methyl ionone terpenes, methyl 4-methyl benzoate, methyl 4-phenyl butyrate, musk ambrette replacer, musk gx 50% in diethyl phthalate, musk gx 50% in DPG, myrtenol, nirvanolide, (E)-2-nonen-1-yl acetate, 2-nonyn-1-al dimethyl acetal, cis-oak lactone, 3-octanone, origanum majorana oil CO₂ extract, perillaldehyde, 2-phenoxyethyl formate, 4-phenyl-2-butanol, phenyl glycol phenyl acetate, 3-phenyl propyl cinnamate, phenyl salicylate, isopropenyl acetate, (R)-(+)-pulegone, reseda acetal, rose absolute (rosa damascena) bulgaria, rose undecene, sandal glycol acetal, satinaldehyde, sodium ferulate, styralyl alcohol, syringaldehyde, tea acetate, tetrahydrofurfuryl phenyl acetate, ortho-thioguaiacol, 3(or 2),4,5-trimethyl octahydro-4,7-methanoinden-5-yl acetate, 4,6,11-trimethyl-5-oxatricyclo(6.2.2.0*4,9*)dodec-6-ene, vanilla bean absolute, vanilla oleoresin bourbon, 4-vinyl phenol and wine lactone, aeolanthus graveolens oil, amber naphthofuran, para-anisaldehyde/methyl anthranilate Schiff's base, beta-bisabolol, capsicum oleoresin CO₂ extract, cuminyl acetate, (E)-beta-damascenone, (R)-gamma-decalactone, (S)-delta-decalactone, 2,5-dimethyl bicyclo(3.2.1)-2-octen-3-yl acetate+1,4-dimethyl bicyclo(3.2.1)-2-octen-3-yl acetate, (R)-gamma-dodecalactone, 2-ethyl-1-hexanol, (R)-gamma-heptalactone, hexanol, (Z)-3-hexen-1-yl phenyl acetate, hexyl acetate, labdanum absolute, para-methyl benzyl acetate, methyl heptadienone, nonanal/methyl anthranilate Schiff's base, ocimenol, Passiflora edulis fruit extract, phenyl acetaldehyde/methyl anthranilate Schiff's base, robinia pseudoacacia absolute, sea resorcylate, delta-tetradecalactone, verbena absolute france, vetiveryl acetate, ylang ylang flower oil I, ylang ylang flower oil, zedoary bark oil, agrumen nitrile, artemisia vestita wall leaf oil, benzyl acetate, benzyl salicylate, butyl 2-naphthyl ether, khella oil, leafy acetal, (R)-ocean propanal, (S)-ocean propanal, octahydro-4,7-methano-1H-indene-5-acetaldehyde+6-methyl-octahydro-4,7-methano-indene-5-carbaldehyde, spearmint oil America, strawberry glycidate 1, vanilla oleoresin bali, veratraldehyde, (Z)-3-hexenyl methyl ether, methyl para-anisate, vanillin, vanillyl acetate. 4-(3,3-dimethyl bicyclo(2.2.1)hept-2-yl)-1-methyl-2-oxabicyclo(2.2.2)octane, 2-phenyl-2-pentenal, and (E)-2,5,9-trimethyl-4,9-decadien-1-al.

Examples of flavoring agents that are known to impart or help impart a sugary flavor include caramel color, sugar cookie flavor, ethyl maltol, malt distillates, marzipan flavor, orris rhizome absolute (iris germanica), orris rhizome absolute (iris pallida sugar cane distillate, brown sugar cinnamon flavor, burnt sugar flavor, maple brown sugar flavor sweet flavor, sweetness enhancerscaramel dione, caramel furanone solution, cinnamon sugar cookie flavor, ethyl furaneol, methyl 2-furoate, praline flavor, pyruvic acid, vanilla sugar, caramel furanone, caramel pentadione, crème brûlée flavor, crème brûlée coffee flavor and strawberry furanone.

Examples of flavoring agents that are known to impart or help impart a sugary aroma include caramel color, cotton candy fragrance, marzipan fragrance, sugar cookie fragrance, sugar fragrance, brown sugar fragrance, caramel dione, diethyl malate, malt distillates, maltyl isobutyrate, mesitene lactone, caramel furanone, caramel furanone solution, caramel pentadione, coffee dione, crème brûlée fragrance, cyclotene hydrate, ethyl furaneol, 1-ethyl-2-methyl propyl 2-butenoate, barley malt extract, menthone lactone, 2-mercaptomethyl pyrazine, methyl bicycloheptenyl methyloxirane carboxylate, strawberry furanone solution, shoyu furanone, spicy pentanone, strawberry furanone, strawberry furanone acetate, toffee furanone, ethyl cyclopentenolone, ethyl maltol, Hordeum vulgare extract (cereal grass), beta-damascenone and 3-phenyl propyl isobutyrate.

Examples of flavoring agents that are known to impart or help impart a caramellic flavor include 2-butyl-3,6-dimethyl pyrazine, 2-butyl-3,5,6-trimethylpyrazine, caramel cappuccino flavor, caramel apple flavor, caramel candy flavor, caramel cashew flavor, caramel cocoa flavor, caramel coconut flavor, caramel coffee flavor, caramel corn flavor, caramel cream flavor, caramel custard flavor, caramel flavor, burnt caramel flavor, caramel fudge flavor, caramel furanone, caramel latte flavor, caramel macchiato flavor, caramel malted mambo flavor, caramel mocha flavor, caramel nut cream flavor, caramel nut flavor, caramel nut fudge flavor, caramel peanut flavor, caramel pecan flavor, caramel toffee flavor, caramel walnut shortbread flavor, coffee dione, crème brûlée flavor, cyclotene hydrate, 2-dimethyl-3-butyl pyrazine, ethyl furaneol, 3-ethyl pyridine, fenugreek distillates, roasted fenugreek flavor, fenugreek resinoid, fenugreek seed oil, 3,4-hexane dione, 2-hydroxy-2-cyclohexenone, barley malt extract, maple flavor 2-(methoxymethyl) pyridine, 3-methyl butyl 2-furyl butyrate, methyl 2-furoate, 6-methyl-pyridine-2-aldehyde, 1-phenyl-1,2-propane dione, 5-propyl-thiophene-2-aldehyde, 2-pyridine carboxaldehyde, pyruvaldehyde, dextro-sorbitol, strawberry furanone, strawberry furanone acetate, strawberry furanone solution, toffee flavor, English toffee flavor, trigonella foenum-graecum essence, trigonella foenum-graecum extract, trigonella foenum-graecum tincture, acetyl propionyl, bananas foster flavor, butter caramel flavor, butyl levo-lactate, iso-butyl lactate, cajeta flavor, caramel pentadione, chocolate caramel flavor, chocolate caramel flavor, white chocolate caramel flavor, chocolate caramel nut flavor, 3,5-cocoa pyrazine, coffee caramel flavor, crème brûlée coffee flavor, crème caramel flavor, cyclohexyl acetic acid, 2,5-dimethyl-3,6-diisobutyl pyrazine, egg nog crème brûlée flavor, 3-ethyl-1,2-cyclopentadione, 5-ethyl-3,4,5,6-tetramethyl cyclohexen-2-one, ethyl vanillin, flan flavor, 2-furoic acid, helichrysum italicum flower absolute, honey distillates, lucuma flavor, 2,3-lutidine, maltyl propionate, molasses flavor, caramelized onion flavor, orange caramel flavor, peanut brittle flavor, pecan caramel flavor, 4-phenyl pyridine, caramel popcorn flavor, 2-propanoyl thiophene, 2-iso-propyl pyrazine, shoyu furanone, tetrahydrofurfuryl acetate, 5-thenyl-thiophene-2-aldehyde, vanilla caramel flavor, 2-vinyl benzofuran, (E)-aconitic acid, almond toffee crunch flavor, almond toffee flavor, butter maple flavor, butter praline flavor, butter toffee flavor, 2-oxo-butyric acid, coffee crème brûlée flavor, coffee distillates, cyclotene, fenugreek absolute, chocolate fudge caramel flavor, furfuryl alcohol, 2-(2-furyl)ethanethiol, honey maple flavor, maple cream flavor, maple nut flavor, maple pecan flavor, toasted marshmallow flavor, 2-(1-mercaptoethyl) furan, 5-methyl furfural, caramelized onion oleoresin, praline flavor, toasted praline flavor, vanilla oleoresin bali, aconitic acid, caramel dione, ethyl crotonate, ethyl (E)-2-crotonate, malt distillates, maltyl isobutyrate, maple furanone, toasted maple nut flavor, rum ether, spicy acetoacetate, acetyl butyryl, ethyl lactate, 2,3-heptane dione, 2-pentyl furan, diacetyl trimer, furfural, furfuryl valerate and 2-methyl butyraldehyde.

Examples of flavoring agents that are known to impart or help impart a caramellic aroma include 4-acetyl-2,5-dimethyl-3(2H)-furanone, 6-acetyl-1,2,3,4-tetrahydropyridine, allyl 2-furoate, amyl 2-furoate, isoamyl pyruvate, butterscotch fragrance, 2-oxobutyric acid, caramel corn fragrance, caramel dione, caramel fragrance, caramel furanone, caramel furanone solution, coffee dione, cyclotene, cyclotene hydrate, diethyl malate, alpha,alpha-dimethyl anisyl acetone, 3-ethyl-1,2-cyclopentadione, ethyl cyclopentenolone, ethyl furaneol, ethyl 4-hydroxybutyrate, ethyl 2-hydroxy-2-methyl butyrate, ethyl-4-hydroxymethyl-3(2H)-furanone, ethyl levulinate propylene glycol ketal, ethyl maltol, 5-ethyl-2,3,4,5-tetramethyl-2-cyclohexen-1-one, 5-ethyl-3,4,5,6-tetramethyl cyclohexen-2-one, fenugreek absolute, fenugreek concrete, fenugreek seed oil, geranyl crotonate, helichrysum italicum flower absolute, helichrysum italicum flower extract, Hordeum vulgare cera, hydroxydimethyl cyclopentenone, 2-hydroxy-3,5,5-trimethyl-2-cyclopenten-1-one, immortelle absolute, levulinic acid, barleymalt extract, malt fragrance, maltol, maltyl isobutyrate, maltyl propionate, maple fragrance, maple furanone, menthone lactone, mesitene lactone, 2-methoxy-3,5-dimethyl-2-cyclopenten-1-one, 5-methyl furfural, methyl levulinate, 2-pentanoyl furan, isopropenyl pyrazine, propyl levulinate, propyl pyruvate, rosa canina seed extract, rosefuran, shoyu furanone, dextro-sorbitol, (S)-strawberry furanone, strawberry furanone acetate, strawberry furanone ethyl ether, (R)-strawberry furanone methyl ether, strawberry furanone solution, toffee furanone, trigonella foenum-graecum essence, trigonella foenum-graecum extract, trigonella foenum-graecum tincture, acetone alcohol, acetyl butyryl, 2-acetyl-3,4,5,6-tetrahydropyridine, isoamyl levulinate, caramel pentadione, crème brûlée fragrance, cyclotene propionate, diethyl 2-hydroxyglutarate, 2,5-diethyl tetrahydrofuran, 3-ethyl-4-methyl cyclotene, 5-ethyl-3-methyl cyclotene, ethyl vanillin, furfuryl acetone, furfuryl decanoate, Hordeum vulgare extract (cereal grass), 2-hydroxy-2-cyclopenten-1-one, 3-hydroxy-3-penten-2-one, cis-2-hydroxy-3,4,5-trimethyl-2-cyclopenten-1-one, isomaltol, mango furanone, 2-mercaptomethyl pyrazine, nutty cyclohexenone, 4-pentenoic acid, 2-propanoyl thiophene, pyruvaldehyde, pyruvic acid, strawberry furanone, 2-thiophene thiol, tonka bean absolute replacer, tonka bean resinoid, vanilla bean absolute (vanilla planifolia), vanilla oleoresin bourbon, amerinal, isobutyl lactate, 3,5-cocoa pyrazine, coffee distillates, 1,2-cyclohexane dione, diacetyl, ethyl (E)-2-crotonate, fenugreek oleoresin, furfural, 2-furyl acetone, geranyl ethyl acetal, 3-mercapto-3-methyl butyl formate, 2-methoxythiazole, 3-methyl butyl 2-furyl butyrate, methyl 2-hydroxy-3-methyl pentanoate, methyl nonane dione, (E)-propyl 2-furan acrylate, strawberry furanone methyl ether, 2,3,5,6-tetramethyl pyrazine, (E)-tiglic acid, tonka bean absolute, (E,E)-2,4-undecadienal, 2-acetyl-3,6-dimethyl pyrazine, 2-acetyl-3,5(or 6)-dimethyl pyrazine, 2-acetyl furan, acetyl propionyl, (R)-gamma-decalactone, ethyl lactate, 3,4-hexane dione, opoponax resin (commiphora erythraea var. glabrescens engler), phenethyl octanoate, tetrahydrofurfuryl acetate, tetrahydrofurfuryl alcohol, vanillyl isobutyrate, dextro-xylose, (E)-aconitic acid, benzyl disulfide, butyl levulinate, 2,3-dimethyl pyrazine, ethyl 4-pentenoate, ethyl pyruvate, ethyl vanillin isobutyrate, furfuryl alcohol, furfuryl octanoate, gamma-heptalactone, 5-hydroxymethyl furfural, malt distillates, 2-methyl furan, opoponax oil (commiphora erythraea var. glabrescens engle), peanut oxazole, vanilla oleoresin bali, aconitic acid, (E)-ethyl tiglate, 2-methyl thio-3,5 or 6-methyl pyrazine, opoponax absolute (commiphora erythraea var. glabrescens engle), 2-pentyl furan, isoamyl 3-(2-furan) propionate, chocolate pyrazine A, cyclohexyl acetic acid, nutty quinoxaline, 2-acetyl-5-methyl furan, isobutyl 2-butenoate, 4-methyl-2,6-dimethoxyphenol, (E,E)-pomarose and trigonella foenum-graecum seed oil CO₂ extract.

Examples of flavoring agents that are known to impart or help impart a maple flavor include caramel pentadione, cyclotene, 2,5-dimethyl-3,6-diisobutyl pyrazine, 3-ethyl-1,2-cyclopentadione, fenugreek absolute, lucuma flavor, maple butter flavor, maple cream flavor, maple distillates, maple flavor, maple nut crunch flavor, maple nut flavor, toasted maple nut flavor, maple pecan cream flavor, maple pecan flavor, maple syrup, maple walnut flavor, butter maple flavor, caramel furanone, cyclotene hydrate, gac fruit distillates, honey maple flavor, maple pumpkin flavor, maple brown sugar flavor, acer spicatum bark extract, caramel dione, red cinchona bark, cyclohexyl acetic acid; fenugreek oleoresin, maple furanone, levisticum officinale root extract; lovage tincture, 5-methyl furfural and ethyl cyclopentenolone.

Examples of flavoring agents that are known to impart or help impart a maple aroma include caramel pentadione, 3-ethyl-4-methyl cyclotene, fenugreek oleoresin, 2-hydroxy-2-cyclopenten-1-one, cis-2-hydroxy-3,4,5-trimethyl-2-cyclopenten-1-one, maple fragrance, acer spicatum bark extract, caramel furanone, caramel furanone solution, red cinchona bark, 1,2-cyclohexane dione, cyclotene, cyclotene hydrate, ethyl cyclopentenolone, trans-2-ethylidene-trans-3-hexenal, fenugreek absolute, geranyl crotonate, menthone lactone, 2-methoxy-3,5-dimethyl-2-cyclopenten-1-one, caramel dione, fenugreek resinoid, maple furanone, shoyu furanone, 2-hydroxy-3,4,5-trimethyl-2-cyclopenten-1-one, 5-methyl furfural, 3-propylidene phthalide, molasses blackstrap, strawberry furanone methyl ether, whiskey lactone and cyclohexyl acetic acid.

Examples of flavoring agents that are known to impart or help impart a cotton candy flavor include cotton candy flavor, maltol, ethyl maltol, strawberry furanone solution, caramel furanone, maltyl isobutyrate and raspberry ketone.

Examples of flavoring agents that are known to impart or help impart a cotton candy aroma include cotton candy fragrance, diethyl 2-hydroxyglutarate, strawberry furanone, ethyl maltol, maltol, strawberry furanone solution, toffee furanone, caramel furanone, heliotropyl acetone and maltyl isobutyrate.

The incorporation of allulose in an amount below its sweetness threshold in a food or beverage product may advantageously be combined with the use of natural and/or synthetic high intensity sweeteners in said food or beverage product.

The term “high intensity sweetener” as used herein refers to a sweetener that has a sweetness by weight at least 10 times that of sucrose (sugar). For example, the sweetness by weight of a high intensity sweetener may be from 10 times to 10,000 times (e.g. 20 times to 9,000 times, such as 50 times to 8,000 times) that of sucrose.

The term “synthetic high intensity sweetener” as used herein refers to a high intensity sweetener that has been produced using one or more synthetic steps. Synthetic high intensity sweeteners include acesulfame K, alitame, aspartame, a glucosylated steviol glycoside, N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L-[alpha]-aspartyl]-L-phenylalanine 1-methyl ester, N-[N-[3-(3-methoxy-4-hydroxyphenyl)propyl]-L-[alpha]-aspartyl]-L-phenylalanine 1-methyl ester, neohesperidin dihydrochalcone, neotame, sucralose and salts and/or solvates thereof.

A specific example of a synthetic high intensity sweetener is sucralose.

The term “natural high intensity sweetener” as used herein refers to a high intensity sweetener obtained from a natural source. For example, a natural high intensity sweetener may be used in its raw form (e.g. as a plant) or may be extracted or purified from the natural source. Examples of natural high intensity sweeteners include abrusoside A, baiyunoside, brazzein, curculin, cyclocarioside I, glycyphyllin, glycyrrhizic acid, hernandulcin, a monk fruit extract, mabinlin, monatin, monellin, mukurozioside, osladin, periandrins, phlomisosides, phloridzin, phyllodulcin, polypodoside A, pterocaryoside A, pterocaryoside B, rubusoside, a stevia extract (e.g. steviol glycosides, or particularly a rebaudioside, such as rebaudioside A to F, M, N and X), thaumatin and trilobatin, and salts and/or solvates thereof.

Specific examples of natural high intensity sweeteners include monk fruit extracts and stevia extracts, as well as any sweet compounds isolated from such extracts (including synthetic equivalents of such compounds).

Monk fruit is the fruit of the siraitia grosvenorii vine, also known as Luo Han Guo. The sweet taste of monk fruit extracts is mainly attributed to a family of compounds known as ‘mogrosides’, examples of which include mogroside V, mogroside IV, mogroside VI, oxomogroside V, mogroside IIIE, neomogroside and siamenoside I. The food or beverage products used in the method of the present invention may comprise monk fruit extracts, as well as sweeteners comprising any one or more mogroside. For example, the food or beverage products may comprise extracts or sweeteners comprising mogroside V.

Stevia, or Stevia rebaudiana, contains sweet compounds in its leaves. These compounds may be extracted to provide stevia extracts. The sweet taste of stevia extracts is mainly attributed to a family of compounds known as ‘steviol glycosides’, examples of which include rebaudiosides rebaudioside A to F, M, N and X), rubusoside, stevioside, and dulcosides. The food or beverage products used in the method of the present invention may comprise stevia extracts, as well as sweeteners comprising any one or more steviol glycoside. For example, the food or beverage products may comprise extracts or sweeteners comprising rebaudioside A (Reb A). The food or beverage products may comprise blends or mixtures of individual steviol glycosides which have been individually isolated, produced and/or purified.

The stevia extract may comprises steviol glycosides in a total amount of at least 90 weight %, preferably in a total amount of 95 weight % or more, relative to the total weight of the stevia extract on a dry solids basis (i.e., of the total dry solids present in the stevia extract, at least 90% by weight is steviol glycosides). For example, the stevia extract may comprise steviol glycosides in a total amount of at least 90, 91, 92, 93, 94, 95, 96, 97, 98 or 99 weight %, relative to the total weight of the stevia extract on a dry solids basis.

The food or beverage products prepared according to the method of the present invention may comprise a stevia extract comprising Rebaudioside A and Stevioside in a combined total amount of at least 70 weight %, preferably in a combined total amount of 75 weight % or more, relative to the total weight of the stevia extract on a dry solids basis. Another stevia extract comprises Rebaudioside B in an amount of from about 15 weight % to about 30 weight %, preferably from about 19 weight % to about 23 weight %, relative to the combined total weight of steviol glycosides in the stevia extract on a dry solids basis.

Further examples of high intensity sweeteners include a synthetic high intensity sweetener that is a glycoside, a synthetic high intensity sweetener that is derived from an amino acid or a protein-based high intensity sweetener.

The term “high intensity sweetener that is a glycoside” refers to a high intensity sweetener that is a molecule in which a sugar is bound to an organic moiety that is not itself a sugar. High-intensity sweeteners that are glycosides include abrusoside A, baiyunoside, cyclocarioside I, dulcoside A, dulcoside B, glycyphyllin, glycyrrhizic acid, a glucosylated steviol glycoside, mogrosides (e.g. mogroside IV, mogroside V), mukurozioside, neomogroside, osladin, periandrins, phlomisosides, phloridzin, polypodoside A, pterocaryoside A, pterocaryoside B, a rebaudioside (e.g. rebaudioside A, rebaudioside B, rebaudioside C, rebaudioside D, rebaudioside E, rebaudioside F, rebaudioside M, rebaudioside N, rebaudioside X), rubusoside, siamenoside, stevia, stevioside, trilobatin and neohesperidin dihydrochalcone.

The term “high intensity sweetener that is derived from an amino acid” refers to a high intensity sweetener that contains at least one amino acid as part of its molecular structure. High intensity sweeteners that are derived from an amino acid include monatin (e.g. monatin, monatin SS, monatin RR, monatin RS, monatin SR), N-[N-[3-(3-hydroxy-4-methoxyphenyl)propyl]-L-[alpha]-aspartyl]-L-phenylalanine 1-methyl ester, N-[N-[3-(3-hydroxy-4-methoxyphenyl)-3-methylbutyl]-L-[alpha]-aspartyl]-L-phenylalanine 1-methyl ester and N-[N-[3-(3-methoxy-4-hydroxyphenyl)propyl]-L-[alpha]-aspartyl]-L-phenylalanine 1-methyl ester, and salts and/or solvates thereof.

The term “protein-based high intensity sweetener” as used herein refers to a high intensity sweetener that is a protein. Protein-based high intensity sweeteners include brazzein, curculin, mabinlin, monellin and thaumatin.

According to another aspect, the present invention relates to a method of modifying or enhancing a flavor of a pharmaceutical product (e.g. a pharmaceutical composition), a nutraceutical product, a medicinal food product, a medicinal beverage product, a dietary food product, a dietary beverage product, a nutritional food product or a nutritional beverage product comprising including in said pharmaceutical product, nutraceutical product, medicinal food product, medicinal beverage product, dietary food product, dietary beverage product, nutritional food product or nutritional beverage product allulose in an amount below its sweetness threshold.

The description of the embodiments of the methods of modifying or enhancing a flavor of a food or beverage product applies mutatis mutandis to the method of modifying or enhancing a flavor of a pharmaceutical product, a nutraceutical product, a medicinal food product, a medicinal beverage product, a dietary food product, a dietary beverage product, a nutritional food product or a nutritional beverage product.

According to another aspect, the present invention relates to the use of allulose in an amount below its sweetness threshold to modify or enhance a flavor of a food or beverage product.

The description of the embodiments of the methods of modifying or enhancing a flavor of a food or beverage product applies mutatis mutandis to the use of allulose in an amount below its sweetness threshold to modify or enhance a flavor of a food or beverage product.

According to another aspect, the present invention relates to a method of preparing a food or beverage product, wherein the method comprises the step of including a flavoring agent and allulose such that the allulose is included in an amount below its sweetness threshold in the food or beverage product. In this method, the allulose is included to modify or enhance a flavor imparted by the flavoring agent to the food or beverage product. The method may comprise including more than one flavoring agent.

As a person of skill in the art will appreciate, the method will also include the conventional steps necessary to make the food or beverage product. For example, the method also includes the step of mixing the other ingredients of the food or beverage product with the allulose and flavoring agent.

In an embodiment, the flavoring agent is combined with the allulose prior to mixing with the other ingredients of the food or beverage product.

The description of the embodiments of the methods of modifying or enhancing a flavor of a food or beverage product applies mutatis mutandis to the method of preparing a food or beverage product.

In another aspect, there is provided a flavored food or beverage product comprising allulose in an amount below its sweetness threshold. The presence of the allulose in the flavored food or beverage product in an amount below its sweetness threshold modifies or enhances a flavor of said food or beverage product.

The description of the embodiments of the methods of modifying or enhancing a flavor of a food or beverage product applies mutatis mutandis to the flavored food or beverage product comprising allulose in an amount below its sweetness threshold.

The flavored food or beverage product may have a sweet flavor. For example, the flavored food or beverage product may have a sweet aromatic flavor, in particular a sweet aromatic flavor perceived primarily or exclusively by retronasal smell. (e.g. a caramellic flavor, a maple flavor, a sugary flavor, a cotton candy flavor or mixtures thereof, all of which flavors are perceived primarily or exclusively by retronasal smell). In an embodiment, the flavored food or beverage product has a cotton candy or salted caramel flavor. In an embodiment, the flavored food or beverage product is a flavored beverage product that has a cotton candy or salted caramel flavor.

The flavored food or beverage product comprises a flavoring agent. The flavored food or beverage product may comprise more than one flavoring agent. The flavored food or beverage product may comprise one or more flavoring agents described herein. For example, the flavored food or beverage product may comprise one or more flavoring agents that impart or help impart a sweet flavor, a sugary flavor, a caramellic flavor, a maple flavor, or a cotton candy flavor.

In an embodiment, the flavored food or beverage product is a flavored beverage product. In an embodiment, the flavored beverage product has a cotton candy or salted caramel flavor and comprises allulose in an amount of about 2.695% or less by weight relative to the total weight of the beverage product. For example, the beverage product may comprise allulose in an amount of 0.10, 0.20, 0.30, 0.40, 0.50, 0.60, 0.70, 0.80, 0.90, 1.00, 1.10, 1.20, 1.30, 1.40, 1.50, 1.60, 1.70, 1.80, 1.90, 2.00, 2.10, 2.20, 2.30, 2.40, 2.50, 2.60, 2.65, 2.69% or less by weight relative to the total weight of the beverage product, as well as all intermediate values.

In an embodiment, the beverage product comprises allulose in an amount of 0.10% to about 2.695% by weight relative to the total weight of the food or beverage product. For example, the beverage product may comprise allulose in an amount of about 0.20% to about 2.695%, about 0.30% to about 2.695%, about 0.40% to about 2.695%, about 0.50% to about 2.695%, about 0.60% to about 2.695%, about 0.70% to about 2.695%, about 0.80% to about 2.695%, about 0.90% to about 2.695%, about 1.00% to about 2.695%, about 1.10% to about 2.695%, about 1.20% to about 2.695%, about 1.30% to about 2.695% or about 1.40% to about 2.695% by weight relative to the total weight of the beverage product, as well as all intermediate values.

The beverage product may comprise allulose in an amount of about 1.40% to about 2.60%, about 1.40% to about 2.50%, about 1.40% to about 2.40%, about 1.40% to about 2.30%, about 1.40% to about 2.20%, about 1.40% to about 2.10%, about 1.40% to about 2.00%, about 1.40% to about 1.90%, about 1.40% to about 1.80%, about 1.40% to about 1.70%, about 1.40% to about 1.60%, about 1.45% to about 1.55%, about 1.46% to about 1.54% or about 1.47% to about 1.53%, about 1.48% to about 1.52% or about 1.49% to about 1.51% by weight relative to the total weight of the beverage product, as well as all intermediate values.

The beverage product may comprise allulose in an amount of about 1.00% to about 2.20%, about 1.00% to about 2.10%, about 1.00% to about 2.00%, about 1.10% to about 2.00%, about 1.10% to about 1.90%, about 1.20% to about 1.90%, about 1.20% to about 1.80%, about 1.30% to about 1.80%, about 1.30% to about 1.70% or about 1.30% to about 1.60% by weight relative to the total weight of the beverage product, as well as all intermediate values.

In an embodiment, the beverage product comprises allulose in an amount of about 1.50% by weight relative to the total weight of the food or beverage product.

### EXAMPLES

Determination of the Sweet-Taste Threshold of Allulose

The sweet-taste threshold of allulose was determined in accordance with FEMA (Flavor Extracts Manufacturing Association) guidance. The standard process described in this guidance requires use of a two-alternative forced choice test (2-AFC testing) against threshold levels of sweetness. FEMA guidance states that the standard for this determination is a 1.5% by weight sucrose aqueous solution (i.e. the sucrose is present in an amount of 1.5% by weight relative to the total weight of the solution). AFC tests are to be performed up to the concentration where the proposed substance exceeds the sweetness levels of sucrose at threshold levels. FEMA guidance further recommends that 30 observations be made to assess the difference in sweetness and that the differences must be found to be statistically significant to assess the effect.

The number of panellists used across replicates always exceeded the minimum of 30 observations as recommended by the FEMA sensory testing guidance. As replicates were performed, beta-binomial statistics were required to be consistent with published requirements (BI, Jian. 2006. Sensory Discrimination tests and Measurements. Chapter. 6, p. 106-129, 1st ed. Blackwell Publishing, Ames, Iowa). In such tests, when the beta-binomial term A exceeds zero, the beta-binomial is required. However, if A is zero or negative, then the panel is not over-dispersed and traditional binomial statistics can be used.

Samples were prepared on the morning of testing. Reference solutions were made as a point of comparison for all tests. The reference solutions were simple solutions of 1.5% by weight sucrose (commercial Domino brand sugar) in water. Test solutions were made from Tate & Lyle Dolcia Prima® allulose syrup standardized such that the amount of allulose in the test solutions was 1.925%, 2.310%, 2.695%, 2.8875%, or 3.080% by weight relative to the total weight of the solution.

Replicated pairs of samples at a single test concentration were chosen from those above and served on a given day. Panellists were presented products in coded 2-oz soufflé cups containing approximately 1.5 oz of liquid, and asked which sample was sweeter. Products were served at room temperature. The serving order was randomized based on a complete block design, such that the order of samples was randomized among panellists and between replicates.

As noted in Table 1, the sucrose solution was chosen as the sweeter sample over the solutions containing 1.925%, 2.310% and 2.695% by weight of allulose. At these levels, the beta binomial A value is negative, so normal binomial statistics apply.

Above these concentrations of allulose, i.e. at 2.8875% by weight of allulose relative to the total weight of the solution, the solutions were considered to be sweeter than the 1.5% by weight sucrose solution. At 3.0800% allulose solids the effect is even more significantly pronounced, showing that a solution of 3.0800% allulose solids is clearly above the sweetness threshold.

TABLE 1

| | | | 2-tail | 1-tail | Beta |
|---|---|---|---|---|---|
| Allulose | | | individual | individual | Binomial |
| weight % | Count | Possible | P-value | P-value | λ value |
| 1.9250 | 45 | 50 | 0.0001 | 0.0001 | −0.11 |
| 2.3100 | 49 | 58 | 0.0001 | 0.0001 | −0.18 |
| 2.6950 | 40 | 60 | 0.0067 | 0.0034 | −0.05 |
| 2.8875 | 26 | 44 | 0.1456 | 0.0728 | 0.06 |
| 3.0800 | 34 | 60 | 0.1831 | 0.0916 | 0.19 |

In Table 1, the “possible” number is the total number of panellists. The “count” number for 1.925%, 2.310% and 2.695% by weight of allulose is the number of panellists who selected the sucrose solution. The “count” number for 2.8875% and 3.0800% by weight of allulose is the number of panellists who selected the allulose solution. The data in Table 1 demonstrate that an allulose solution containing 2.695% by weight or less allulose relative to the total weight of the solution can be considered to contain allulose in an amount below its sweetness threshold.

Demonstrating the Flavor Modifying or Enhancing Effects of Allulose

In order to demonstrate the flavor modifying or enhancing properties of allulose when used in sub-sweetening amounts, the following experiments were performed.

### Example 1—Cotton Candy Flavor

Cotton candy flavor samples in accordance with Table 2 below were prepared by weighing all of the ingredients into a container and blending until fully mixed. All of the samples are non-sweetened (i.e. they do not contain a sweetener in an amount that is above its sweetness threshold, and therefore do not have a sweet taste).

TABLE 2
Cotton Candy Flavor Samples

| | Control Sample | | Test Sample | |
|---|---|---|---|---|
| Ingredient | wt % | GRAMS | wt % | GRAMS |
| DOLCIA PRIMA ® Allulose | 0.00 | 0.00 | 2.1127 | 42.2535 |
| Syrup, 71% dry solids | | | | |
| Flavor, N&A Cotton Candy | 0.20 | 4.00 | 0.20 | 4.00 |
| Deionized Water | 99.8 | 1996 | 97.6873 | 1953.7465 |
| TOTAL | 100 | 2000 | 100 | 2000 |

The N&A Cotton Candy flavor was obtained from Givaudan (product code YX-953-327-3). This flavor does not contain a sweetener (i.e. it does not impart a sweet taste on the samples). DOLCIA PRIMA® was obtained from Tate & Lyle. The DOLCIA PRIMA® Allulose Syrup comprises allulose in an amount of 71% by weight on a dry solids basis. Accordingly, in the Test Sample, allulose was present at an amount of approximately 1.5% by weight relative to the total weight of the solution. The deionized water was produced by reverse osmosis.

The samples in Table 2 were subjected to 2-AFC testing. As already described herein, an AFC test is an alternative forced choice test. It asks a panelist to identify the sample that is most or least intense in a specified attribute among a given number of samples. A 2-AFC test chooses among 2 samples, a 3-AFC test chooses among 3 samples, etc. The attributes that are specified are generally attributes which panelists are likely to be able to recognize and identify a difference. A 2-AFC for sweetness would present panelists with two samples and ask them of the two which is sweeter. These differ from triangle tests or other types of tests in that an attribute is specified for the panelist to focus on. AFC testing is the standard to use when pursuing FEMA GRAS™ approval for materials with flavor modifying or enhancing properties.

Samples were prepared on the morning of testing. Panelists were asked to identify which taste sample (i.e. Control Sample or Test Sample) was stronger in cotton candy flavor and if they had a preference between the two samples. Standard ambient fluorescent lighting was used in sensory isolation booths, as is typical in sensory facilities. Products were served blinded and randomized in 2-oz soufflé cups identified with randomized three digit product codes.

The response questionnaires were run using Compusense Cloud. Replicates were not performed for this study. Therefore, simple binomial statistics were applied. The results are presented in Table 3.

TABLE 3

| | | | 2-tail individual | 1-tail individual |
|---|---|---|---|---|
| Test Type | Count | Possible | P-value | P-value |
| 2-AFC Flavor | 27 | 30 | <0.0001 | 0.0001 |
| Preference | 22 | 30 | 0.0081 | 0.0001 |

In Table 3, the “possible” number is the total number of panellists. The “count” number is the number of panellists who selected the test sample over the control sample.

27 panelists out of 30 (p<0.0001) found the Test Sample cotton candy flavored water to have a stronger cotton candy flavor than the Control Sample cotton candy flavored water. Furthermore, 22 of 30 panellists (p<0.0081) preferred the Test Sample over the Control Sample. Accordingly, when used at sub-sweetening levels, allulose was found to have a highly statistically significant impact on both the intensity of the cotton candy flavor as well as a clear influence on the acceptance patterns of the Test sample containing allulose.

In conclusion, incorporating allulose into a cotton candy flavored beverage in an amount below its sweetness threshold enhanced the cotton candy flavor and increased the preference for the beverage.

### Example 2—Salted Caramel Flavor

Salted caramel flavor samples in accordance with Table 4 below were prepared by weighing all of the ingredients into a container and blending until fully mixed. All of the samples are non-sweetened (i.e. they do not contain a sweetener in an amount that is above its sweetness threshold, and therefore do not have a sweet taste).

TABLE 4
Salted Caramel Flavor Samples

| | Control Sample | | Test Sample | |
|---|---|---|---|---|
| Ingredient | wt % | GRAMS | wt % | GRAMS |
| DOLCIA PRIMA Allulose | 0.00 | 0.00 | 2.1127 | 42.2535 |
| Syrup, 71% dry solids | | | | |
| Flavor, N&A Salted Caramel | 0.20 | 4.00 | 0.20 | 4.00 |
| Deionized Water | 99.8 | 1996 | 97.6873 | 1953.7465 |
| TOTAL | 100 | 2000 | 100 | 2000 |

The N&A Salted Caramel flavor was obtained from Flavor & Fragrance Specialities (product code YX-226E 032). This flavor does not contain a sweetener (i.e. it does not impart a sweet taste on the samples). DOLCIA PRIMA® was obtained from Tate & Lyle. The DOLCIA PRIMA® Allulose Syrup comprises allulose in an amount of 71% by weight on a dry solids basis. Accordingly, in the Test Sample, allulose was present at an amount of approximately 1.5% by weight relative to the total weight of the solution. The deionized water was produced by reverse osmosis.

The samples in Table 3 were subjected to 2-AFC testing.

Samples were prepared on the morning of testing. Panellists were asked to identify which sample (i.e. Control Sample or Test Sample) was stronger in salted caramel flavor and if they had a preference between the two samples. Standard ambient fluorescent lighting was used in sensory isolation booths, as is typical in sensory facilities. Products were served blinded and randomized in 2-oz soufflé cups identified with randomized three digit product codes.

The response questionnaires were run using Compusense Cloud. Replicates were not performed for this study. Therefore, simple binomial statistics were applied. The results are presented in Table 5.

TABLE 5

| | | | 2-tail individual | 1-tail individual |
|---|---|---|---|---|
| Test Type | Count | Possible | P-value | P-value |
| 2-AFC Flavor | 28 | 30 | <0.0001 | 0.0034 |
| Preference | 25 | 30 | 0.0002 | 0.0728 |

In Table 5, the “possible” number is the total number of panellists. The “count” number is the number of panellists who selected the test sample over the control sample. 28 of 30 (p<0.0001) panellists perceived the Test Sample salted caramel flavored water to have a stronger salted caramel flavor than the Control Sample salted caramel flavored water. Furthermore, 25 of 30 panellists (p<0.0002) preferred the Test Sample over the Control Sample. Accordingly, when used at sub-sweetening levels, allulose was found to have a highly statistically significant impact on both the intensity of the salted caramel flavor as well as a clear influence on the acceptance patterns of the Test sample containing allulose.

In conclusion, incorporating allulose into a salted caramel flavored beverage in an amount below its sweetness threshold enhanced the salted caramel flavor and increased the preference for the beverage.

1. A method of modifying or enhancing a flavor of a food or beverage product comprising including in said food or beverage product allulose in an amount below its sweetness threshold.

2. A method according to claim 1, wherein the method Is a method of enhancing a flavor of a food or beverage product.

3. A method according to claim 1, wherein the allulose is included in the food or beverage product in an amount of about 2.695% by weight or less relative to the total weight of the food or beverage product.

4. A method according to claim 3, wherein the allulose is included in the food or beverage product in an amount of about 2.20% by Weight or less relative to the total weight of the food or beverage product.

5. A method according to claim 3, wherein the allulose is included in the food or beverage product in an amount of about 0.10% by weight to about 2:20% by weight relative to the total Weight of the food or beverage product.

6. A method according to claim 5, wherein the allulose is included in the food or beverage product in an amount of about 0.50% by weight to about 2.20% by weight relative to the total weight of the food or beverage product.

7. A method according to claim 5, wherein the allulose is included in the food or beverage product in an amount of about 1.00% by weight to about 2.20% by weight relative to the total weight of the food or beverage product.

8. A method according to claim 5, wherein the allulose is included in the food or beverage product in an amount of about 1.20% by weight to about 2.00% by weight relative to the total weight of the food or beverage product.

9. A method according to claim 5, wherein the allulose is included in the food or beverage product in an amount of about 1.20% by weight to about 1.80% by weight relative to the total weight of the food or beverage product.

10. A method according to claim 5, wherein the allulose is included in the food or beverage product in an amount of about 1.40% by weight to about 1.60% by weight relative to the total weight of the food or beverage product.

11. A method according to claim 5, wherein the allulose Is included in the food or beverage product in an amount of about 1.50% by weight relative to the total weight of the food or beverage product.

12. A method according to claim 1, wherein the flavor is a sweet flavor.

13. A method according to claim 12, wherein the sweet flavor is a sweet aromatic flavor.

14. A method according to claim 13, wherein the sweet aromatic flavor is perceived primarily or exclusively by retronasal smell.

15. A method according to claim 13, wherein the sweet aromatic flavor is selected from the group consisting of caramellic flavor, maple flavor, sugary flavor and cotton candy flavor.

16. A method according to claim 13, wherein the sweet aromatic flavor is selected from the group consisting of caramellic flavor and cotton candy flavor.

17. A method according to claim 16, wherein the caramellic flavor is a salted caramel flavor.

18. A method according to claim 1, wherein the method is a method of modifying or enhancing a flavor of a beverage product.

19. Use of allulose in a method according to claim 1.

20. A flavored food or beverage product comprising allulose in an amount below its sweetness threshold.

21. A flavored food or beverage product according to claim 20, wherein the flavored food or beverage product comprises allulose in an amount of about 2.695% by weight or less relative to, the total weight of the flavored food or beverage product.

22. A flavored food or beverage product according to claim 21, Wherein the flavored food or beverage product comprises allulose in an amount of about 2.20% by weight or less relative to the total weight of the flavored food or beverage product.

23. A flavored food or beverage product according to claim 21, wherein the flavored food or beverage product comprises allulose in an amount of about 0.10% to about 2.20% by weight relative to the total weight of the flavored food or beverage product.

24. A flavored food or beverage product according to claim 23, wherein the flavored food or beverage product comprises allulose in an amount of about 0.50% to about 2.20% by weight relative to the total weight of the flavored food or beverage product.

25. A flavored food or beverage product according to claim 23, wherein the flavored food or beverage product comprises allulose in an amount of about 1.00% to about 2.20% by weight relative to the total weight of the flavored food or beverage product.

26. A flavored food or beverage product according to claim 23, wherein the flavored food or beverage product comprises allulose in an amount of about 1.20% to about 2.00% by weight relative to the total weight of the flavored food or beverage product.

27. A flavored food or beverage product according to claim 23, wherein the flavored food or beverage product comprises allulose in an amount of about 1.20% to about 1.80% by weight relative to the total weight of the flavored food or beverage product.

28. A flavored food or beverage product according to claim 23, wherein the flavored food or beverage product comprises allulose in an amount of about 1.40% to about 1.60% by weight relative to the total weight of the flavored food or beverage product.

29. A flavored food or beverage product according to claim 23, wherein the flavored food or beverage product comprises allulose in an amount of about 1.50% by weight relative to the total weight of the flavored food or beverage product.

30. A flavoring composition comprising allulose and one or more flavoring agents.

31. A flavoring composition according to claim 30, wherein the flavoring composition comprises one or more flavoring agents that Impart or help impart a sweet flavor, a sugary flavor, a caramellic flavor, a maple flavor or a cotton candy flavor.

32. A flavoring composition according to claim 31, wherein the flavoring composition comprises one or more flavoring agents that impart or help impart a caramellic flavor or a cotton candy flavor.

33. Use of a flavoring composition comprising allulose and one or more flavoring agents in a method according to claim 1.

34. A method according to claim 1, wherein one or more flavoring agents is combined with the allulose prior to mixing with the other ingredients of the food or beverage product.
